(19) United States
(12) Patent Application Publication
(10) Pub. No.: US 2026/0208119 A1
(43) Pub. Date: Jul. 23, 2026

(54) PREPARATION METHOD OF NH2-UiO-66 ENCAPSULATED SULFAMIC ACID AND USE THEREOF

(71) Applicant: CHINA THREE GORGES UNIVERSITY, Yichang City (CN)

(72) Inventors: Jun ZHAO, Yichang City (CN); Rui ZHANG, Yichang City (CN); Wenwen DONG, Yichang City (CN); Dan BA, Yichang City (CN); Dongsheng LI, Yichang City (CN)

(73) Assignee: CHINA THREE GORGES UNIVERSITY, Yichang City (CN)

(21) Appl. No.: 19/434,497

(22) Filed: Dec. 29, 2025

(30) Foreign Application Priority Data
Jan. 2, 2025 (CN) 202510004141.9

(51) Int. Cl. B01D 67/00; B01D 71/02

(52) U.S. Cl. CPC B01D 67/0044; B01D 71/02; B01D 2323/082; B01D 2323/10; B01D 2325/26; B01D 2325/42

(57) ABSTRACT

Disclosed is a method for preparing a proton-conductive material from sulfamic acid(SA)@NH₂-UiO-66. A method for preparing SA@NH₂-UiO-66 includes the steps of first synthesizing NH₂-UiO-66 through a solvothermal reaction of zirconium tetrachloride and 2-aminoterephthalic acid, and then encapsulating SA by a continuous dynamic concentration encapsulation method.

### CROSS-REFERENCE TO RELATED APPLICATIONS

This application claims priority to Chinese Application No. CN202510004141.9, having a filing date of Jan. 2, 2025, the entire contents of which are hereby incorporated by reference.

### TECHNICAL FIELD

The present invention belongs to the field of preparation of a proton exchange membrane material and relates to a method for preparing a proton-conductive material from sulfamic acid(SA)@NH₂-UiO-66.

### BACKGROUND OF THE INVENTION

Proton Exchange Membrane Fuel Cells (PEMFCs) are considered one of the most promising power sources for future electric vehicles due to the advantages of high conversion efficiency, remarkable power density, cleanliness and sustainability. As one of the core components in PEMFCs, a proton exchange membrane plays a crucial role in proton transport and separating the electrolytes of the anode and cathode. In recent years, metal-organic framework (MOF) materials have garnered widespread attention from researchers due to their characteristics of high porosity, high specific surface area, structural tunability, and modifiability. Effective proton transfer within the MOF materials can be achieved by means of encapsulating or grafting substances such as acids, bases, histamine, triazoles, imidazoles, or ionic liquids to introduce proton carriers (acids/bases) within the pores of the MOF materials, thereby constructing continuous hydrogen bonding pathways or increasing the proton concentration within the pores. Among the numerous MOF materials, NH₂-UiO-66 stands out as a highly representative amino MOF. It is derived from UiO-66, constructed by connecting Zr-O cluster secondary building units (SBUs) with 2-aminoterephthalic acid, and exhibits excellent chemical stability, thermal stability, and ultra-high water stability. The different connection modes between bridging ligands and metals result in the formation of two types of triangular windows with sizes of 0.6 nm and 1.0 nm. The amino groups within the pores exhibit weak alkalinity or electron donor characteristics, indicating that NH2-UiO-66 has the ability to encapsulate acidic molecules or amphoteric molecules for enhancing proton transport.

In materials with ultra-high proton conductivity (σ≥10⁻¹S·cm−1), strongly acidic molecules such as H₂SO₄ and H₃PO₄ are confined therein and serve as proton sources and proton carriers. However, strongly acidic molecules can attack metal-ligand bonds/inorganic clusters, destroying the original structure of MOF. Only a very small number of MOFs that are resistant to strong acids or covalent organic framework (COF) meet this condition. Although the proton conductivity exhibited by weakly acidic guest molecules or functional groups confined within the pores of MOF is generally low, the MOF framework is not easily destroyed. Therefore, it is necessary to encapsulate as many guest molecules conducive to proton transport as possible within the limits of the MOF material stability, so as to achieve the purpose of enhancing proton conductivity. Sulfamic acid (H₂NSO₃H, SA) molecules with medium-strong acidity (pKa=1) are dipole bodies, which generally exist in the form of ⁺H₃NSO₃⁻in solution. It contains both a proton donor (NH³⁺) and a proton acceptor (SO³⁻), capable of forming an extensive hydrogen bond network with water molecules or another sulfamic acid molecule to achieve efficient proton transport.

Encapsulating proton carriers via immersion is a simple and effective strategy to enhance the proton conduction performance of MOF materials. Currently, the main substances encapsulated in MOF materials with excellent proton conduction performance are strongly acidic non-volatile acids. This method is only suitable for a small number of MOF materials with high stability, and also suffers from the problems of long immersion time and easy leakage of guest molecules. To address this problem, exploring new methods for encapsulating guest molecules and new proton carriers plays an important role.

### SUMMARY OF THE INVENTION

The objective of the present invention is to provide a method for preparing SA@NH₂-UiO-66 and a proton-conductive material thereof. The SA@NH₂-UiO-66 material exhibits strong stability, high encapsulation efficiency, high proton conductivity, and good cycling stability.

The present invention provides a method for preparing SA@NH₂-UiO-66 and a proton-conductive material thereof, the composition and mass percentage content thereof are as follows: NH₂-UiO-66 accounts for 16-36%, and SA accounts for 64-84%.

The present invention provides a method for preparing SA@NH₂-UiO-66, comprising the following steps:
(1) dissolving a zirconium salt and a ligand in a solvent, then adding acetic acid, and conducting a solvothermal reaction to obtain NH₂-UiO-66;
(2) dissolving SA in anhydrous methanol, adding NH₂-UiO-66, stirring at 40-50° C. for 1 h-3 h, continuing stirring at room temperature for 18 h-24 h, filtering the mixture, and activating the obtained product under vacuum conditions at 70-90° C. for 10-15 h to obtain SA@NH₂-UiO-66; and

(3) placing the SA@NH₂-UiO-66 sample in a vacuum drying oven at 80° C. to dry for 12 h, loading 5-10 mg of the dried sample into a tablet pressing chamber, pressurizing to 0.38 Gpa, stabilizing for over 20 seconds, reducing the pressure, and taking out the pressed sample tablet to obtain the proton-conductive material.

The zirconium salt in step (1) is selected from any one of zirconium tetrachloride, basic zirconium tetrachloride and zirconium nitrate. The organic ligand described in the present invention is 2-aminoterephthalic acid.

In step (1), the solvothermal reaction is conducted at 120° C. for 24-72 h, followed by vacuum drying at 120° C. for 24 h.

In step (2), the mass percentages are as follows: NH₂-UiO-66 accounts for 16-36%, and SA accounts for 64-84%.

In step (2), the activation process is conducted under vacuum conditions.

Another technical solution of the present invention is to provide a proton-conductive material, which comprises SA@NH₂-UiO-66 prepared using the aforementioned preparation method.

The present invention provides a method for testing the proton conduction performance of SA@NH₂-UiO-66, comprising the following steps:
placing the proton-conductive material on a glass slide, taking a gold wire to cover the top of the material and fix both ends with insulating adhesive, then, applying conductive silver adhesive onto the top of the pressed tablet, letting it stand for half a minute, and after the conductive silver adhesive is completely dried, flipping the pressed tablet and repeating the above operation. Winding the endpoints of the two gold wires covering the top and bottom of the material around conductive posts of a four-sided test bench respectively, then placing it in a constant temperature and humidity chamber, and connecting it to the four-sided test bench via wires for alternating current (AC) impedance testing.

The beneficial effects of the present invention are as follows:
1. The present invention provides SA@NH₂-UiO-66, which is prepared by encapsulating SA by means of a continuous dynamic concentration encapsulation method. Compared with conventional immersion encapsulation, this method has a shorter preparation process time, milder synthesis conditions, and higher encapsulation amount. Moreover, the prepared material exhibits significantly improved proton conductivity and high cycling stability.
2. The present invention provides SA@NH₂-UiO-66 that is less prone to leakage of the guest molecules. Compared to the MOF materials that encapsulate low boiling point and high acidic molecules, it prolongs the retention time of the proton source guest molecules and can maintain high conductivity for a long time.

### BRIEF DESCRIPTION OF DRAWINGS

FIG. 1 is a comparison diagram between NH₂-UiO-66 and simulated PXRD in Example 4.

FIG. 2 is a PXRD comparison diagram of NH₂-UiO-66 after immersion in SA solutions of different concentrations in Example 4.

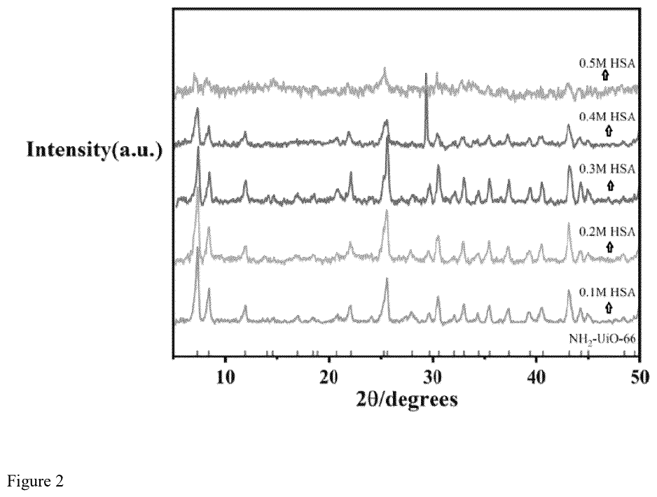

FIG. 3 is a PXRD comparison diagram of NH₂-UiO-66 at different heating times during immersion in the SA solution in Example 4.

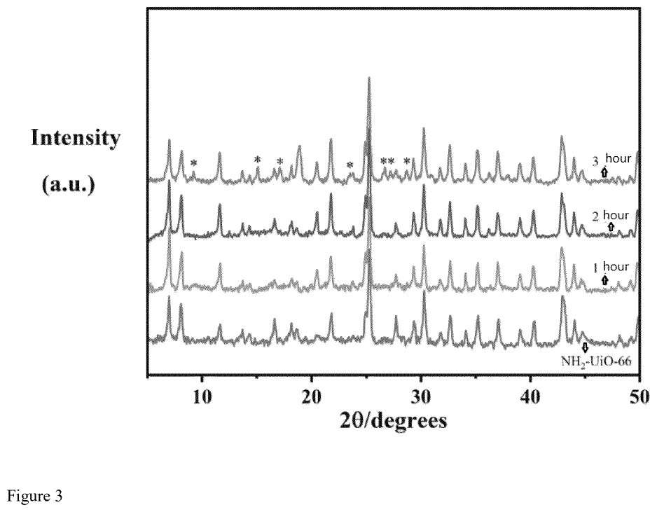

FIG. 4 is a physical comparison diagram of NH₂-UiO-66 before and after immersion in the SA solution in Example 4.

FIG. 5 is an infrared comparison diagram of NH₂-UiO-66 before and after immersion in the SA solution in Example 4.

FIG. 6 is a comparison diagram of saturated N₂ adsorption and desorption of NH2-UiO-66 before and after immersion in the SA solution in Example 4.

FIG. 7 is a pore distribution schematic diagram of NH₂-UiO-66 before and after immersion in the SA solution in Example 4.

FIG. 8 is a proton conductivity diagram of NH₂-UiO-66 in Example 4.

FIG. 9 is a proton conductivity diagram of NH₂-UiO-66 after immersion in the SA solution in Example 4.

FIG. 10 is an Arrhenius fitting diagram of NH₂-UiO-66 after immersion in the SA solution in Example 4.

FIG. 11 is a 7-day cyclic conductivity diagram of NH₂-UiO-66 after immersion in the SA solution in Example 4.

FIG. 12 is a Nyquist diagram of NH₂-UiO-66 measured after being placed for 210 days following immersion in the SA solution in Example 4.

### DETAILED DESCRIPTION OF THE INVENTION

To clarify the objectives, technical solutions and advantages of the present invention, the present invention will be further described in detail below with reference to the accompanying drawings.

### Example 1

(1) ZrCl₄ (0.5592 g, 2.4 mmol) and H₂BDC-NH₂ (0.4348 g, 2.4 mmol) were dissolved in 60 ml of N,N-dimethylformamide (DMF), 7.2 ml of acetic acid was slowly added dropwise, the mixed solution was transferred into a polytetrafluoroethylene bottle, and placed in an oven at 120° C. for 72 h. After natural cooling, the mixture was centrifuged, the sample was washed with 5 ml of pure water and 5 ml of anhydrous methanol, and conducted vacuum drying at 120° C. for 24 h to obtain an activated NH₂-UiO-66 sample.

(2) SA (0.0291 g) was dissolved in 20 ml of anhydrous methanol to prepare a 0.3 mol/L solution, 100 mg of the activated NH₂-UiO-66 was added, stirred at 45° C. for 2 h, then the heating was turned off, and the mixture was continuously stirred for 18 h to volatilize the anhydrous methanol. After encapsulation was completed, the mixture was filtered, washed with 3 ml of ethanol for three times, and activated under vacuum at 80° C. for 12 h to obtain SA@NH₂-UiO-66.

### Example 2

(1) ZrCl₄ (0.5592 g, 2.4 mmol) and H₂BDC-NH₂ (0.4348 g, 2.4 mmol) were dissolved in 60 ml of DMF, 7.2 ml of acetic acid was slowly added dropwise, the mixed solution was transferred into a polytetrafluoroethylene bottle, and placed in an oven at 120° C. for 48 h. After natural cooling, the mixture was centrifuged, the sample was washed with 5 ml of pure water and 5 ml of anhydrous methanol, and conducted vacuum drying at 120° C. for 24 h to obtain an activated NH₂-UiO-66 sample.

(2) SA (0.0291 g) was dissolved in 20 ml of anhydrous methanol to prepare a 0.3 mol/L solution, 100 mg of the activated NH₂-UiO-66 was added, stirred at 45° C. for 2 h, then the heating was turned off, and the mixture was continuously stirred for 18 h to volatilize the anhydrous methanol. After encapsulation was completed, the mixture was filtered, washed with 3 ml of ethanol for three times, and activated under vacuum at 80° C. for 12 h to obtain SA@NH₂-UiO-66.

### Example 3

(1) ZrCl₄ (0.2796 g, 1.2 mmol) and H₂BDC-NH₂ (0.2174 g, 1.2 mmol) were dissolved in 30 ml of DMF, 3.6 ml of acetic acid was slowly added dropwise, the mixed solution was transferred into a polytetrafluoroethylene bottle, and placed in an oven at 120° C. for 24 h. After natural cooling, the mixture was centrifuged, the sample was washed with 5 ml of pure water and 5 ml of anhydrous methanol, and conducted vacuum drying at 120° C. for 24 h to obtain an activated NH₂-UiO-66 sample.

(2) SA (0.0291 g) was dissolved in 20 ml of anhydrous methanol to prepare a 0.3 mol/L solution, 100 mg of the activated NH₂-UiO-66 was added, stirred at 45° C. for 1 h, 2 h, or 3 h respectively, then the heating was turned off, and the mixture was continuously stirred for 18 h to volatilize the anhydrous methanol. After encapsulation was completed, the mixture was filtered, washed with 3 ml of ethanol for three times, and activated under vacuum at 80° C. for 12 h to obtain SA@NH₂-UiO-66.

### Example 4

(1) ZrCl₄ (0.2796 g, 1.2 mmol) and H₂BDC-NH₂ (0.2174 g, 1.2 mmol) were dissolved in 30 ml of DMF, 3.6 ml of acetic acid was slowly added dropwise, the mixed solution was transferred into a polytetrafluoroethylene bottle, and placed in an oven at 120° C. for 24 h. After natural cooling, the mixture was centrifuged, the sample was washed with 5 ml of pure water and 5 ml of anhydrous methanol, and conducted vacuum drying at 120° C. for 24 h to obtain an activated NH₂-UiO-66 sample.

(2) SA (0.0097 g, 0.0194 g, 0.0291 g, 0.0388 g, 0.0485 g) was respectively dissolved in 20 ml of anhydrous methanol to prepare solutions with concentrations of 0.1 M, 0.2 M, 0.3 M, 0.4 M, and 0.5 M in sequence, 100 mg of the activated NH₂-UiO-66 was added, stirred at 45° C. for 2 h, then the heating was turned off, and the mixture was continuously stirred for 18 h to volatilize the anhydrous methanol. After encapsulation was completed, the mixture was filtered, washed with 3 ml of ethanol for three times, and activated under vacuum at 80° C. for 12 h to obtain SA@NH₂-UiO-66.

(3) 20 mg of the SA@NH₂-UiO-66 sample was placed in a vacuum drying oven at 80° C. to dry for 12 h. 5-10 mg of the dried sample was placed in a miniature tablet press for tablet-pressing, pressurized to 0.38 Gpa, and stabilized for over 20 seconds. The pressure was reduced, and the pressed sample tablet was taken out to obtain the proton-conductive material.

Meanwhile, 20 mg of the NH₂-UiO-66 sample obtained in step (2) was placed in a vacuum drying oven at 80° C. to dry for 12 h, 5-10 mg of the dried sample was placed in a miniature tablet press for tablet-pressing, pressurized to 0.38 Gpa, and stabilized for over 20 seconds. The pressure was reduced, and the pressed sample tablet was taken out as a control sample.

### Performance Testing:

1. Frame Structure Analysis

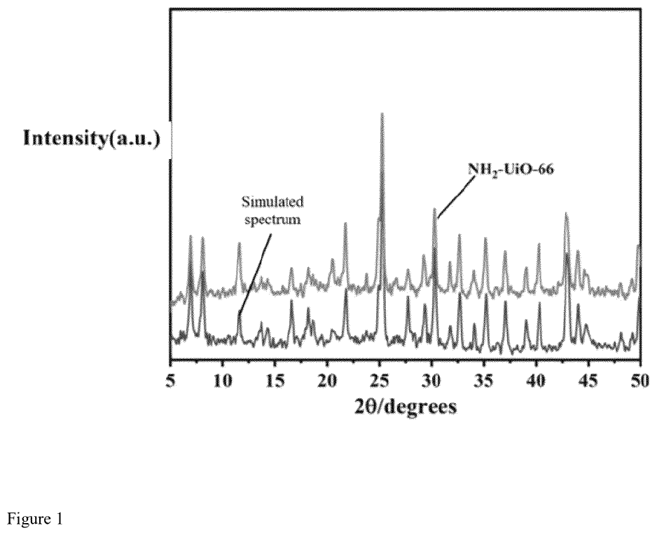

The activated NH₂-UiO-66 sample prepared through step (1) in Example 4 was subjected to continuous scanning using a graphite-monochromatized copper target X-ray (ν=1.5406 Å) within the range of 5° to 50°, with a step size of 0.02° and a scanning speed of 5°/min. The scanned results were compared with the simulated single-crystal powder pattern obtained from the Mercury software. Comparison of the two patterns showed that the activated NH₂-UiO-66 sample prepared through step (1) in Example 4 had peaks that were completely consistent in position with those of the simulated single-crystal powder diffraction pattern, and there were no additional diffraction peaks. This indicated that the activated NH₂-UiO-66 sample synthesized in this step was pure NH₂-UiO-66. The comparative powder diffraction pattern was shown in FIG. 1.

### 2. Analysis of Optimal Encapsulation Concentration

According to the specific steps in Example 4, SA was encapsulated in SA solutions of different concentrations. Diffraction Pattern 2 was obtained after testing. As could be seen from the pattern, the crystallinity of the activated NH₂-UiO-66 decreased gradually with the increase in the concentration of SA. Impurity peaks appeared in the diffraction peaks when the concentration of SA exceeded 0.3 mol/L. To maintain the stability and purity of the activated NH₂-UiO-66 sample during the encapsulation process of SA, 0.3 mol/L was thus selected as the optimal encapsulation concentration.

### 3. Analysis of Optimal Encapsulation Time

According to the specific steps described in Example 3, the influence of different heating times was investigated in a 0.3 mol/L SA solution. Diffraction Pattern 3 was obtained after testing. As could be seen from the pattern, as the heating time increased, impurity peaks appeared in the powder diffraction peaks. Therefore, a heating time of 2 h was recommended.

### 4. Infrared Analysis

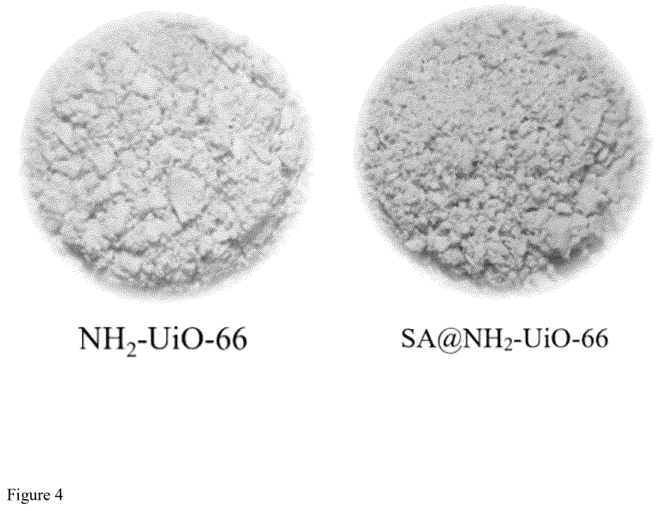

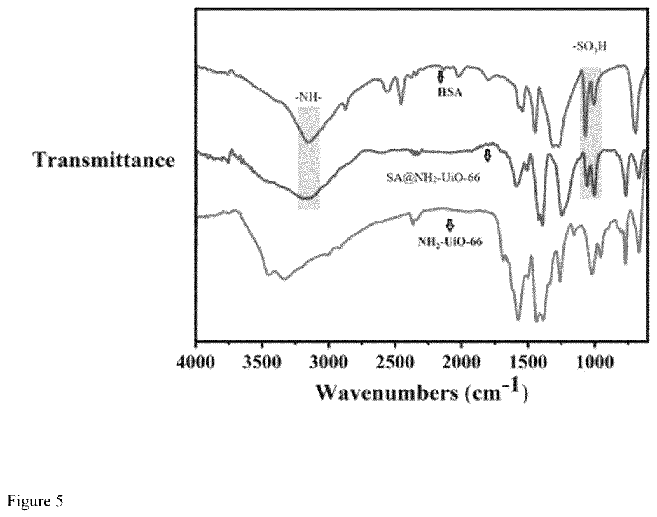

Two samples of NH₂-UiO-66 before and after immersion in a 0.3 mol/L SA solution in Example 4 (as shown in FIG. 4) were dried at 80° C. for 1 day and then subjected to infrared testing. The infrared spectra were shown in FIG. 5, there were stretching vibration peaks of O=S=O at 1002 cm⁻¹ and 1064 cm⁻¹, and a new peak appeared at 1215 cm⁻¹, which could be attributed to the vibration of C—S bonds. The double peak absorption of primary amines at 3300 cm⁻¹ was converted into a single peak absorption of secondary amines, and underwent a blue shift to 3147 cm⁻¹. It could thus be inferred that SA was successfully bound to the primary amine groups on the activated NH₂-UiO-66, forming new chemical bonds and extensive hydrogen bonds.

5. BET specific surface area analysis

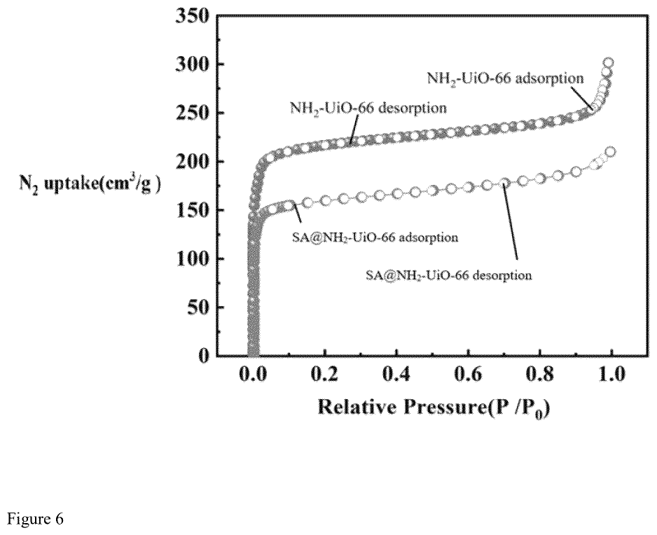

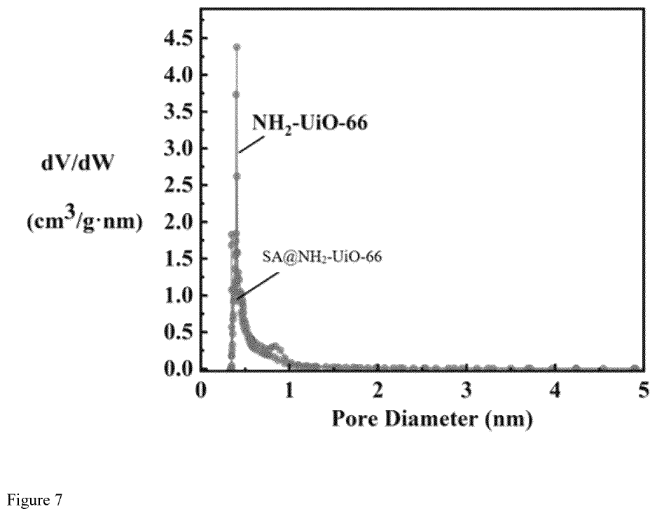

The specific surface area of the sample was tested based on the adsorption-desorption experiment of saturated nitrogen gas. Before conducting the adsorption-desorption experiment, two samples of NH₂-UiO-66 before and after immersion in a 0.3 mol/L SA solution in Example 4 were deeply activated: 100 mg of the sample was weighed and subjected to solvent exchange with 10 ml of anhydrous methanol at room temperature for three days, with the solvent being replaced every 8 hours (10 ml×12 times). Subsequently, the supernatant was removed by centrifugation, and the obtained sample was placed in a vacuum drying oven at 120° C. to activate for 24 h. Finally, it was activated again on a BET testing instrument at 120° C. for 6 h to completely remove the anhydrous methanol molecules within the sample. The fully activated sample was tested for its adsorption of saturated nitrogen gas at 77 K. The adsorption-desorption results of the saturated nitrogen gas were shown in FIG. 6 and FIG. 7. At 77 K and 1 standard atmospheric pressure, the saturated nitrogen gas adsorption capacities of two samples of NH₂-UiO-66 before and after immersion in an SA solution were 210.75 cm³/g and 301.61 cm³/g, respectively. Furthermore, the surface areas of the two samples were evaluated to be 642.23 m²/g and 899.54 m²/g respectively through computer fitting of the adsorption-desorption results. The total pore volumes of the two samples in the test were determined to be 0.3277 cm³/g and 0.4690 cm³/g, respectively. In contrast, the sample of NH₂-UiO-66 after immersion in a SA solution exhibited a significant reduction in total N₂ adsorption capacity, specific surface area, and pore volume, which confirmed that a large number of SA molecules were present inside the pores of the NH₂-UiO-66 sample.

### 6. Analysis of AC Impedance Test

The level of sample impedance and the magnitude of proton conductivity were related to amino groups on the framework, SA within the pores, water molecules, as well as hydrogen bonds generated by these three components.

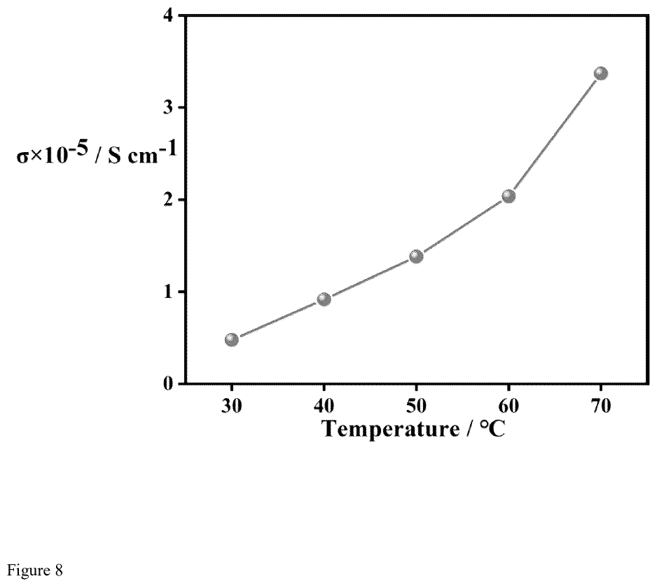

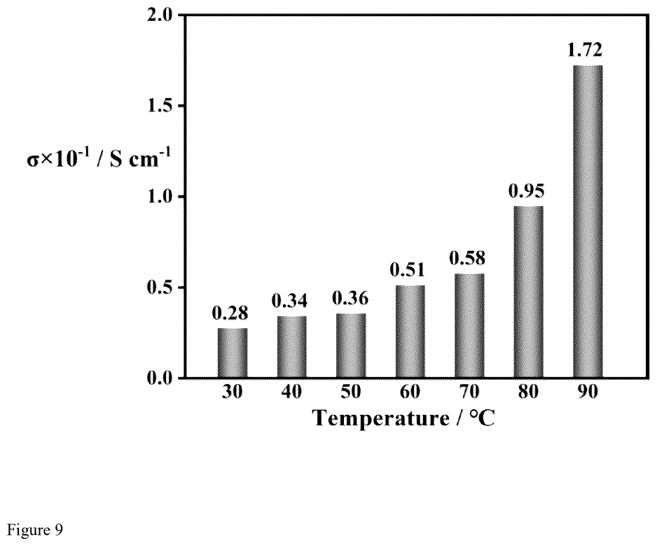

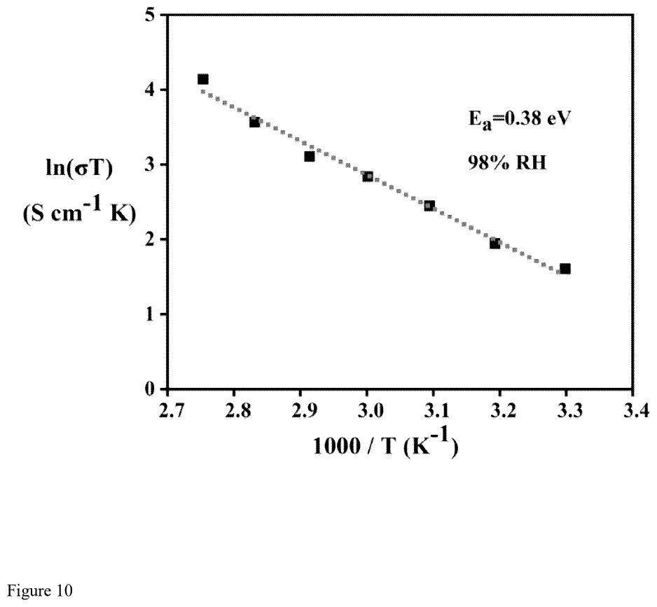

The proton-conductive material and control sample from Example 4 were pressed into tablets and placed in an XK-CTS80Z constant temperature and humidity chamber for impedance analysis using Solartron S1-1260 and S1-1296 EIS impedance analyzers. The analysis results were shown in FIG. 8 and FIG. 9. The conductivity of the activated NH2-UiO-66 sample at 70° C. and 98% RH was 3.24×10⁻⁵ S/cm, while the conductivity of the sample of SA@NH₂-UiO-66 reached 0.172 S/cm at 90° C. and 98% RH, which was 10⁵ times higher than that of the activated NH₂-UiO-66 sample. The activation energy obtained through least squares fitting was 0.38 eV, as shown in FIG. 10. It was confirmed that a large number of SA molecules and water molecules in the pores formed a long-range ordered hydrogen bond network, which played a crucial role in proton transport. Samples of SA@NH₂-UiO-66 from Example 1 and Example 2 were tested under the same conditions, with conductivities of 0.168 S/cm and 0.170 S/cm, respectively.

### 7. Stability Analysis

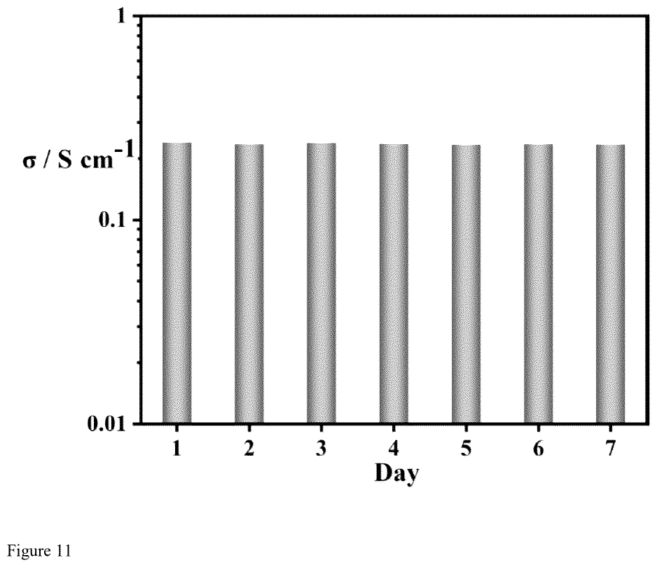

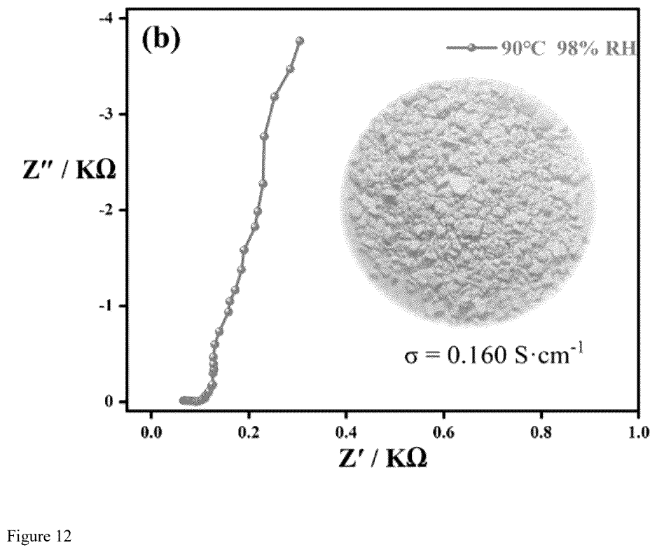

A good material should not only possess outstanding performance but also exhibit good stability and cyclicity to ensure its long-term use and preservation. The sample of NH₂-UiO-66 after immersion in a 0.3 mol/L SA solution in Example 4 was tested continuously for 7 days under an environment of 98% humidity and 90° C. The test results, as shown in FIG. 11, showed that its conductivity decreased by only 2%, which was almost negligible. Subsequently, the pressed tablet after testing was subjected to XRD diffraction. It was found that the diffraction pattern was basically consistent with the diffraction pattern before testing, which confirmed that the main framework was not destroyed and exhibited excellent cycling performance. Subsequently, the sample of NH₂-UiO-66 after immersion in a 0.3 mol/L SA solution in Example 4, which had been placed in an open system at room temperature for 210 days, was subjected to the AC impedance test again. The test results, as shown in FIG. 12, indicated that the sample still achieved a proton conductivity of 0.160 S/cm despite being left open for 210 days, confirming that this material possessed excellent stability.

In summary, NH₂-UiO-66, encapsulated with SA through this method, exhibited remarkably high proton conductivity, excellent cycling performance, and stability. Additionally, its preparation process was simple and easy to operate, with a short SA encapsulation time and a significant increase in conductivity, thus endowing it with great potential for the preparation of a novel proton exchange membrane.

The examples described are preferred embodiments of the present invention, however, the present invention is not limited to the aforementioned embodiments. Any obvious improvements, substitutions or variations that can be made by those skilled in the art without departing from the essential content of the present invention shall fall within the protection scope of the present invention.

1. A method for preparing a proton-conductive material from sulfamic acid(SA)@NH2-UiO-66, wherein the method comprises the following steps:
(1) dissolving a zirconium salt and a ligand in a solvent, then adding acetic acid, and conducting a solvothermal reaction to obtain NH2-UiO-66;
(2) dissolving SA in anhydrous methanol, adding NH 2-UiO-66, stirring at 40-50° C. for 1 h−3 h, continuing stirring at room temperature for 18 h-24 h, filtering the mixture, and activating the obtained product under vacuum conditions at 70-90° C. for 10-15 h to obtain SA@NH2-UiO-66; and
(3) placing the SA@NH 2-UiO-66 sample in a vacuum drying oven at 80° C. to dry for 12 h, loading 5-10 mg of the dried sample into a tablet pressing chamber, pressurizing to 0.38 Gpa, stabilizing for over 20 seconds, reducing the pressure, and taking out the pressed sample tablet to obtain the proton-conductive material.

2. The method according to claim 1, wherein the zirconium salt in step (1) is selected from any one of zirconium tetrachloride, basic zirconium tetrachloride and zirconium nitrate.

3. The method according to claim 1, wherein in step (1), the solvothermal reaction is conducted at 120-140° C. for 24-72 h, followed by vacuum drying at 110-120° C. for 12-24 h.

4. The method according to claim 1, wherein in step (2), the mass percentages are as follows: NH₂-UiO-66 accounts for 16-36%, and SA accounts for 64-84%.
